(19) United States
(12) Patent Application Publication
(10) Pub. No.: US 2011/0297004 A1
(43) Pub. Date: Dec. 8, 2011

(54) ULTRASONIC BREW TECHNOLOGY SYSTEMS

(76) Inventor: Mark Figura, Shorewood, IL (US)

(21) Appl. No.: 13/152,278

(22) Filed: Jun. 3, 2011

Related U.S. Application Data
(60) Provisional application No. 61/351,182, filed on Jun. 3, 2010.

(51) Int. Cl. A47J 31/44

(52) U.S. Cl. 99/290

(57) ABSTRACT

Ultrasonic Brew Technology Systems is a coffee brewing system with a brew ring having the capability of emitting ultrasonic waves for use in agitation of coffee grounds during a coffee brewing episode. Ultrasonic Brew Technology Systems utilizes low voltage direct current to power the circular brew ring which may be comprised of stainless steel. The brew ring may frictionally-fit about the periphery of a brewing basket of a coffee maker (on an outside circumference of the periphery of a brewing basket of a coffee maker or on/in the inside periphery.) Agitation of the coffee grounds by the ultrasonic circular waves creates an increased pulsated-distance between each of the coffee granules thereby creating a greater surface area contact between the water and the coffee grounds, creating higher efficiency and fuller flavored coffee. The brew ring may frictionally-fit about the periphery of a brewing basket of a coffee maker (on an outside circumference of the periphery of a brewing basket of a coffee maker, on/in the inside periphery), or integrated seamlessly into the “pull-out”/“swing-out” basket.

### CROSS-REFERENCE TO RELATED APPLICATION

The present application is related to and claims priority from prior provisional application Ser. No. 61/351,182, filed Jun. 3, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of coffee makers and more specifically relates to ultrasonic accessories for coffee makers.

### 2. DESCRIPTION OF THE RELATED ART

Many individuals in modern society drink coffee made from the coffee bean. The coffee beans of the coffee plant are picked, processed and dried and then are roasted to varying degrees depending on the desired flavor. The roasted beans are then ground into granules and brewed with hot water to create coffee. There are many different kinds of coffeemakers that utilize a number of different brewing principles but in the most common types of coffeemakers, fresh coffee grounds are placed into a paper or metal screen filter which is a conically-shaped basket and then placed over a glass or ceramic coffee pot. Cold water is poured into a separate chamber and when the brewing process begins, the cold water is heated with coils and pumped into the filter basket where it percolates through the coffee grounds and extracts the flavor of the coffee granules.

The coffee brewing process can be affected by the efficiency of the brewing machine. If water percolates through the coffee grounds too fast, the cost of the brewed coffee goes up because of incomplete extraction of the coffee flavor. If the hot water is not evenly spread over the surface area of the coffee grounds in the filter basket, much of the coffee grounds go virtually uncontacted. In the conventional brewing process, caking of the coffee grounds often occurs and “short circuiting” of the percolation process takes place when cracking of the cake (passages are created) in which the water freely passes through leaving partially utilized coffee grounds. The highest efficiency of any brewing process would achieve the greatest percentage of surface area contact of each coffee granule.

Various attempts have been made to solve the above-mentioned problems such as those found in U.S. Pat. Nos. 5,358,725; 6,634,279; 4,779,520; 2008/0032030; 2011/0000379; U.S. Pat. Nos. 6,758,130; and 5,880,364. This prior art is representative of coffee brewing systems. None of the above inventions and patents, taken either singly or in combination, is seen to describe the invention as claimed.

Ideally, an ultrasonic coffee brewing system should provide greater efficiency and increased flavor, and yet, would operate reliably and be manufactured at a modest expense. Thus, a need exists for a reliable ultrasonic coffee brewing accessory to increase brewing efficiency, reduce cost, and to avoid the above-mentioned problems.

### BRIEF SUMMARY OF THE INVENTION

In view of the foregoing disadvantages inherent in the known coffee brewing systems art, the present invention provides a novel ultrasonic coffee brewing system. The general purpose of the present invention, which will be described subsequently in greater detail is to provide reduced brewing costs, higher efficiency of coffee grounds, and fuller flavor.

Ultrasonic Brew Technology Systems is a coffee brewing system disclosed herein preferably comprising a brew ring having the capability of emitting ultrasonic waves for use in agitation of coffee grounds during a coffee brewing episode. The coffee grounds comprise granules. Ultrasonic Brew Technology Systems utilizes low voltage direct current to power the circular brew ring which may be comprised of stainless steel. The brew ring may frictionally-fit about the periphery of a brewing basket of a coffee maker (on an outside circumference of the periphery of a brewing basket of a coffee maker or on/in the inside periphery.) On cylindrical brewing baskets, the brew ring may be fit to a bottom-point-circumference. The brew ring may comprises a timer in certain embodiments and/or an activation button and/or a temperature sensor powered by a low voltage direct current source such as a watch battery, allowing ultrasonic waves to be emitted. The brew ring comprises a height of about ½ inch and a width of about ½ inch in preferred embodiments.

The brew ring may be tunable to a user-preferred frequency to optimize folding of the coffee grounds during the coffee brewing episode such that continuous folding of the coffee grounds with incoming water in a 360 degree pattern takes place during the coffee brewing episode. Agitation of the coffee grounds by the ultrasonic circular waves creates an increased pulsated-distance between each of the coffee granules thereby creating a greater surface area contact between the water and the coffee grounds. The resulting greater surface area contact of the water with the coffee grounds allows fewer coffee grounds to be used per a given amount of coffee brewed than in a traditional process and yet supply a fuller flavor.

A method of using an ultrasonic brew technology system is also disclosed herein preferably comprising the steps of: installing a brew ring about a brewing basket of a coffee maker having a capability of emitting ultrasonic waves for use in agitation of coffee grounds during a coffee brewing episode; activating the brew ring to emit ultrasonic waves; agitating coffee grounds thereby creating a greater surface area contact ratio of water with the coffee grounds; and brewing the coffee grounds during a coffee brewing episode.

The present invention holds significant improvements and serves as an ultrasonic coffee brewing system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Ultrasonic Brew Technology Systems, constructed and operative according to the teachings of the present invention.

FIG. 1 shows a perspective view illustrating a conical version of the ultrasonic brew technology systems according to an embodiment of the present invention.

FIG. 2 is a perspective view illustrating a cylindrical version of the ultrasonic brew technology system according to an embodiment of the present invention of FIG. 1.

FIG. 3 is a perspective view illustrating an after-market version of the ultrasonic brew technology systems with a timer button and battery according to an embodiment of the present invention of FIG. 1.

FIG. 4 is a perspective view illustrating an integrated version of the ultrasonic brew technology systems according to an embodiment of the present invention of FIG. 1.

FIG. 5 is a flowchart illustrating a method of use for the ultrasonic brew technology systems according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a brewing accessory for coffee maker systems and more particularly to an ultrasonic brewing accessory for coffee maker systems as used to reduce the cost and improve the flavor of brewing coffee.

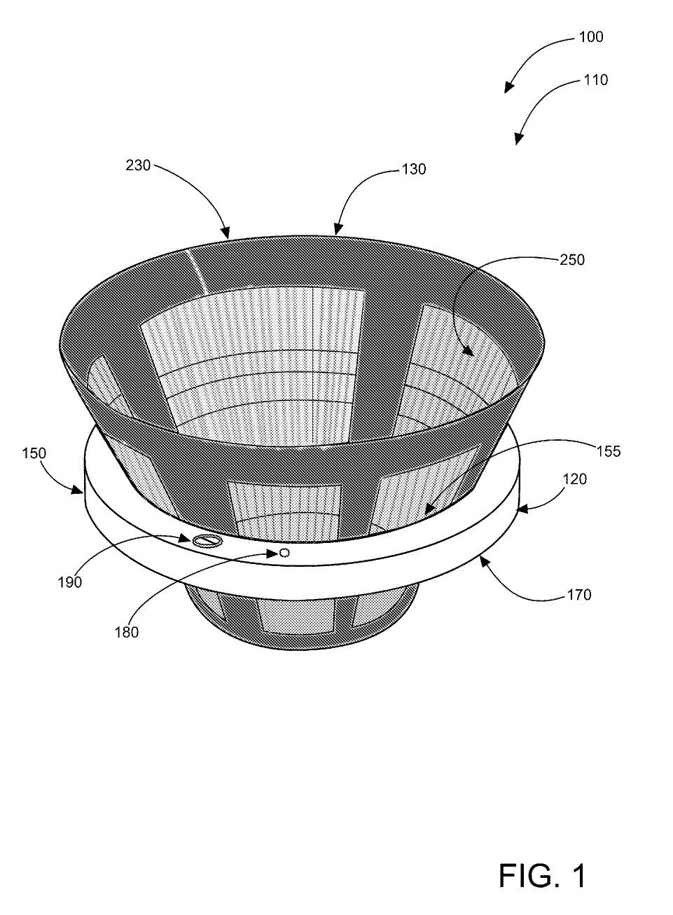

Referring to the drawings by numerals of reference there is shown in FIG. 1, a perspective view illustrating conically-shaped version 110 of ultrasonic brew technology systems 100 according to an embodiment of the present invention. Brew ring 120 is circular with an inclined inner surface and frictionally-fits about a periphery of brewing basket 130 of coffee maker 140 (in after-market applications) and may comprise stainless steel or another non-corrosive material. Brew ring 120 is tapered to fit conically-shaped version 110 of brewing basket 130 wherein brew ring 120 frictionally-fits on outside circumference 150 of the periphery of brewing basket 130 of coffee maker 140. Brew ring 120 may be tapered about inner circumference 155 to fit outside circumference 150 of brewing basket 130 or brew ring 120 may be tapered about outside circumference 150 to fit inner circumference 155 of brewing basket 130. Brew ring 120 may alternately frictionally-fit on inner circumference 155 of the periphery of brewing basket 130 of coffee maker 140. Ultrasonic brew technology systems 100 may be used with brewing basket 130 having metal screen filter 250 or a paper filter. Brew ring 120 is able to be adjusted to a user-preferred frequency to optimize continuous folding of coffee grounds 200 by emitting ultrasonic waves 210 for use in agitation of coffee grounds 200 during a coffee brewing episode.

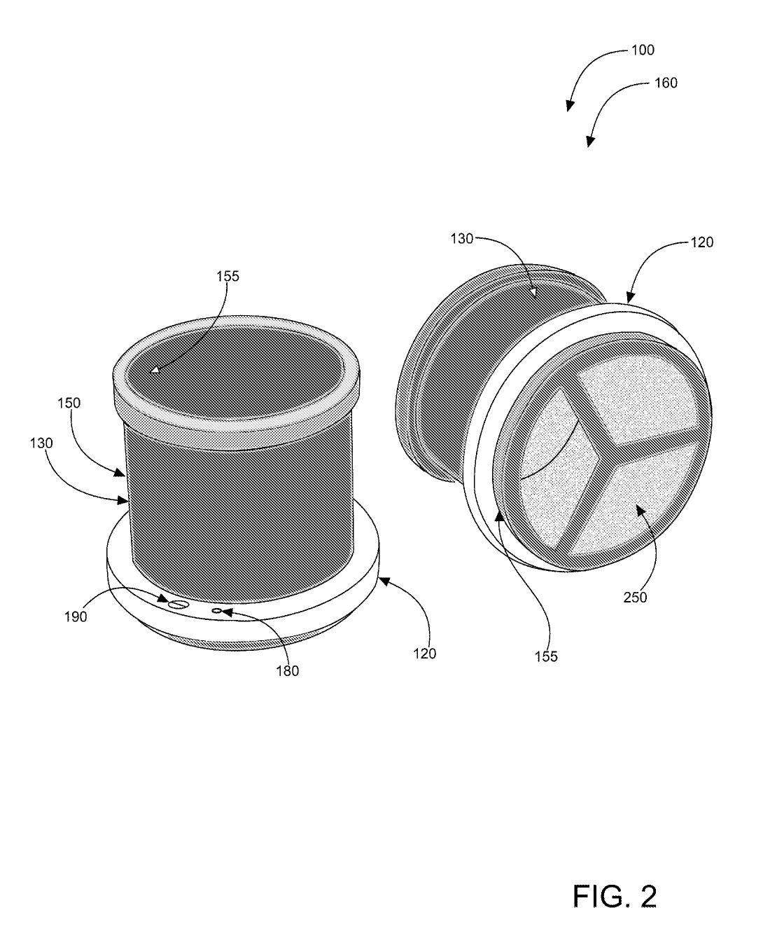

Referring now to FIG. 2, a perspective view illustrating cylindrical version 160 of ultrasonic brew technology systems 100 according to an embodiment of the present invention of FIG. 1. Brew ring 120 preferably comprises a width of about ½ inch and a height of about ½ inch. Brew ring 120 may comprise a friction-fit to a mid-point-circumference on conically-shaped brewing basket 130 or friction-fit to a bottom-point-circumference on cylindrical version 160 of brewing basket 130. Brew ring 120 may be an after-market accessory for existing coffeemaker(s) 140 or brew ring 120 may be constructed integrally with newly manufactured coffee maker(s) 140. Using the present invention serves to decrease costs in coffee brewing processes, thus is suitable for both residential and commercial applications (such as those used in franchises such as StarBucks®, Dunkin' Doughnuts®, Office Machines for example Bunn®, and the like.) It should be appreciated that the embodiments described herein may be used with industrial coffeemakers having multiple baskets or those larger/smaller in size.

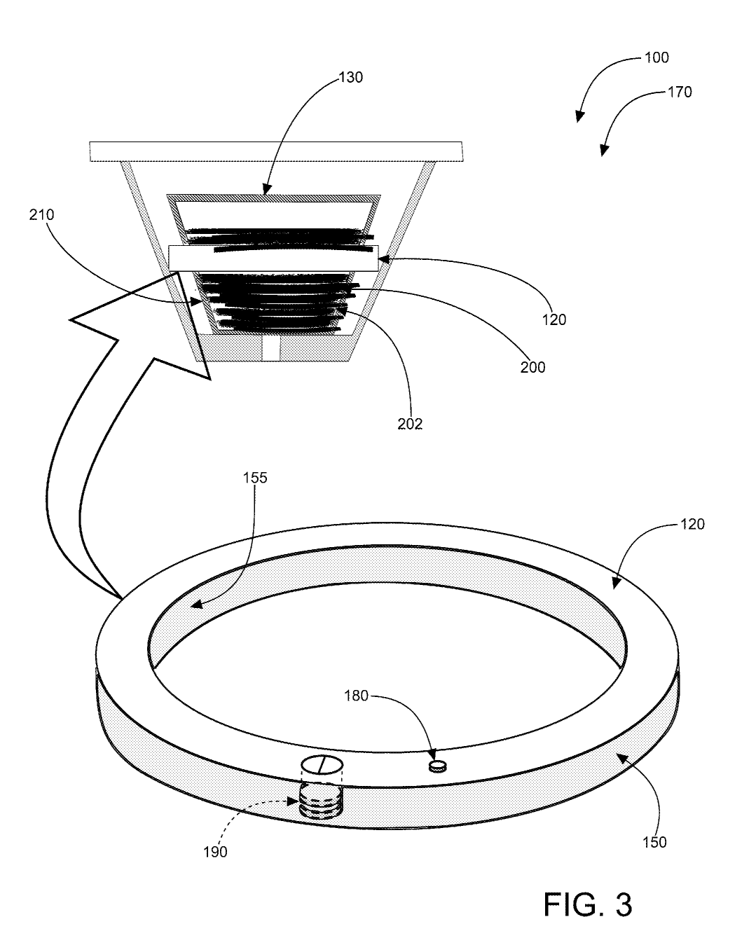

Referring now to FIG. 3, a perspective view illustrating after-market version 170 of ultrasonic brew technology systems 100 with timer button 180 and battery 190 according to an embodiment of the present invention of FIG. 1. Brew ring 120 preferably operates on a low voltage direct current source allowing ultrasonic resonations 210 to be emitted which may be tunable to a user-preferred frequency to optimize folding of coffee grounds 200 during a coffee brewing episode. AC versions may also be available in alternate embodiments. Those with ordinary skill in the art will now appreciate that upon reading this specification and by their understanding the art of altering as described herein, methods of frequency changing and manipulation will be understood by those knowledgeable in such art. For example a rheostat may be used or other equivalent means.

Brew ring 120 may comprise a timer which may be controlled via timer button 180 but in other embodiments may be controlled via a temperature sensor. The operating power is supplied via low voltage direct current such as found in watch battery 190. Aftermarket versions may comprise a sodium oxide type watch battery 190 to power ultrasonic waves 210 emitted from brew ring 120 but in other embodiments, brew ring 120 may comprise electrical contacts 220 on an outside periphery of filter housing 230 wherein low voltage electrical contacts 220 make contact with mating contacts 225 integral with housing of coffeemaker 140 providing power for brew ring 120 during a brewing episode.

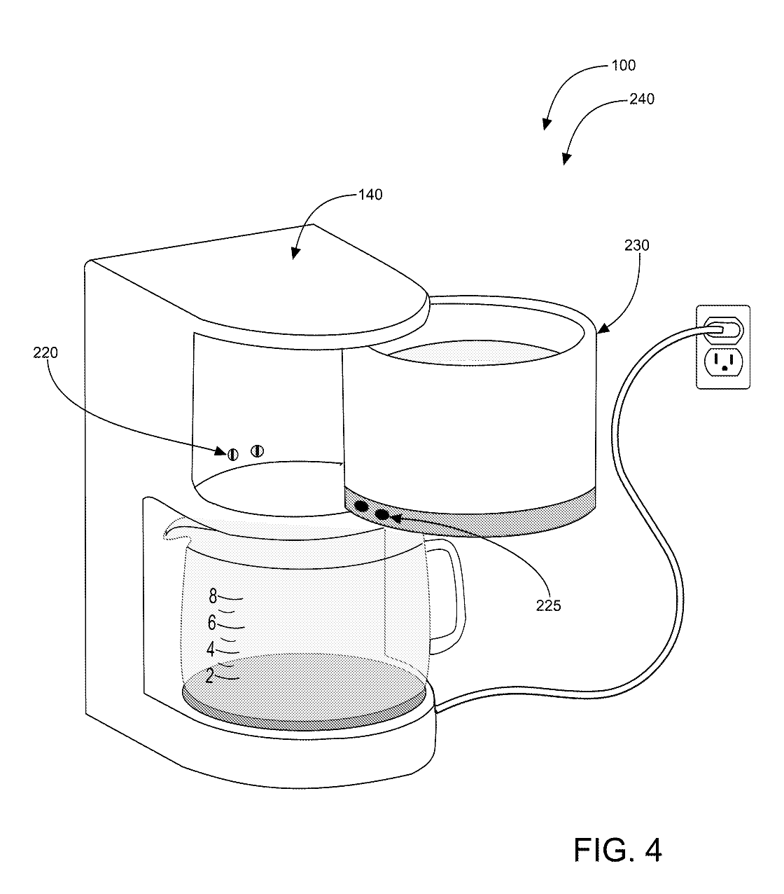

Referring now to FIG. 4, a perspective view illustrating integrated version 240 of ultrasonic brew technology systems 100 according to an embodiment of the present invention of FIG. 1. Integrated version 240 preferably comprises the lower band with two electrical contacts 225. The band may be about ¾ of an inch wide makes contact with mating contacts 225 which will cycle the device. The basket may not be necessary in OEM versions only in aftermarket versions in both cylindrical and conical baskets. Incoming water is agitated with coffee granules 202 via ultrasonic waves 210 emitted from brew ring 120 in a 360 degree pattern within filter brewing basket 130 during coffee brewing episode to achieve optimum coffee granules 202 to water contact. Ultrasonic waves 210 are emitted at a frequency of greater than 20 kilohertz in most embodiments. Coffee grounds 200 comprise coffee granules 202 wherein agitation by ultrasonic waves 210 creates an increased pulsated-distance between each of coffee granules 202 thereby creating a greater surface area contact of water with coffee grounds 200 and frequency provides greater release of coffee granule 202 macro-particulate. Thus, as desired greater surface area contact of water with coffee grounds 200 allows fewer coffee grounds 200 to be used during a coffee brewing episode.

Ultrasonic brew technology system 100 may be sold as kit 440 comprising the following parts: at least one brew ring 120 (cylindrical and/or conical); and at least one set of user instructions. Ultrasonic brew technology system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, parts may be sold separately, etc., may be sufficient.

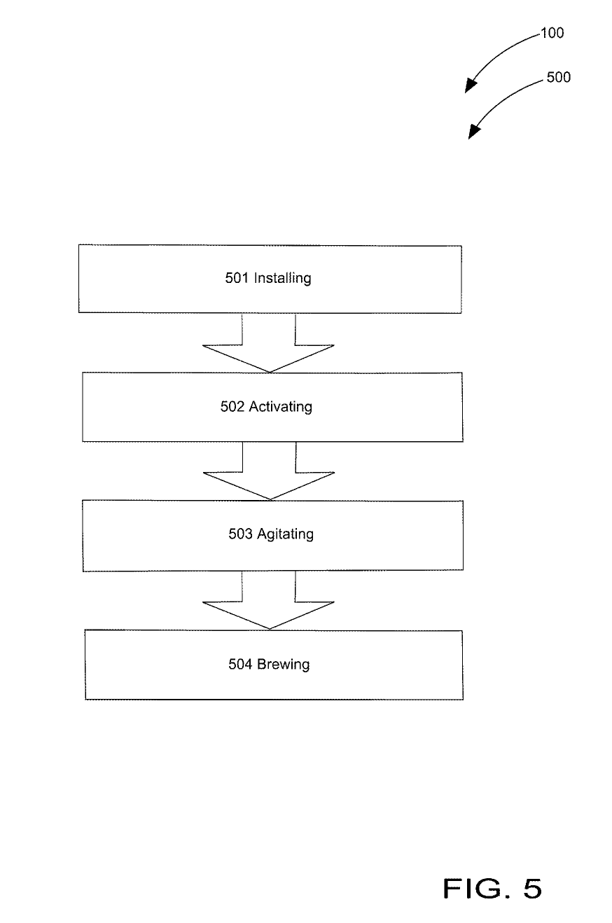

Referring now to FIG. 5, a flowchart illustrating a method of use 500 for ultrasonic brew technology systems 100 according to an embodiment of the present invention of FIGS. 1-4. A method of using ultrasonic brew technology systems 100 preferably comprising the steps of: step one 501 installing a brew ring 120 having a capability of emitting ultrasonic waves 210 for use in agitation of coffee grounds 200 during a coffee brewing episode about brewing basket 130 of coffee maker 140; step two 502 activating brew ring 120 to emit ultrasonic waves 210; step three 503 agitating coffee grounds 200 thereby creating a greater surface area contact ratio of water with coffee grounds 200; and step four 504 brewing coffee grounds 200 during a coffee brewing episode.

It should be noted that steps 502 and 503 are optional steps and may not be implemented in all cases. Optional steps of method 500 are illustrated using dotted lines in FIG. 5 so as to distinguish them from the other steps of method 500. It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An ultrasonic brew technology system comprising:
a brew ring having a capability of emitting ultrasonic waves for use in agitation of coffee grounds during a coffee brewing episode; and
a low voltage direct current source;
wherein said brew ring frictionally-fits about a periphery of a brewing basket of a coffee maker;
wherein said low voltage direct current source powers said brew ring allowing said ultrasonic waves to be emitted;
wherein said agitation of said coffee grounds by said ultrasonic waves creates an increased pulsated-distance between each of said coffee grounds thereby creating a greater surface area contact of water with said coffee grounds; and
wherein said greater surface area contact of said water with said coffee grounds allows fewer coffee grounds to be used during said coffee brewing episode.

2. The ultrasonic brew technology system of claim 1 wherein said brew ring frictionally-fits on an outside circumference of the periphery of said brewing basket of said coffee maker.

3. The ultrasonic brew technology system of claim 1 wherein said brew ring frictionally-fits on an inside circumference of the periphery of said brewing basket of said coffee maker.

4. The ultrasonic brew technology system of claim 1 wherein said ultrasonic waves are emitting at a frequency of greater than 20 kilohertz.

5. The ultrasonic brew technology system of claim 1 wherein said brew ring is tapered about an inner circumference of said brew ring.

6. The ultrasonic brew technology system of claim 5 wherein said brew ring is tapered to fit a conically-shaped version of said brewing basket.

7. The ultrasonic brew technology system of claim 1 wherein said brew ring is circular.

8. The ultrasonic brew technology system of claim 1 wherein said brew ring comprises a timer.

9. The ultrasonic brew technology system of claim 8 wherein said timer is controlled via an activation button.

10. The ultrasonic brew technology system of claim 1 wherein said brew ring is controlled via a temperature sensor.

11. The ultrasonic brew technology system of claim 1 wherein said brew ring comprises stainless steel.

12. The ultrasonic brew technology system of claim 1 wherein said brew ring is tunable to a user-preferred frequency to optimize folding of said coffee grounds during said coffee brewing episode.

13. The ultrasonic brew technology system of claim 12 wherein said brew ring is tunable to said user-preferred frequency to optimize continuous said folding of said coffee grounds with incoming said water through 360 degrees during said coffee brewing episode.

14. The ultrasonic brew technology system of claim 1 wherein said coffee grounds comprise granules.

15. The ultrasonic brew technology system of claim 1 wherein low voltage direct current source comprises a watch battery.

16. The ultrasonic brew technology system of claim 1 wherein said brew ring comprises a height of about ½ inch.

17. The ultrasonic brew technology system of claim 16 wherein said brew ring comprises a width of about ½ inch.

18. The ultrasonic brew technology system of claim 6 wherein said brew ring is friction-fit to a mid-point-circumference on said conically-shaped said brewing basket.

19. The ultrasonic brew technology system of claim 7 wherein said brew ring is friction-fit to a bottom-point-circumference on a cylindrical version of said brewing basket.

20. An ultrasonic brew technology system comprising:
a brew ring having a capability of emitting ultrasonic waves for use in agitation of coffee grounds during a coffee brewing episode; and
a low voltage direct current source;
wherein said coffee grounds comprise granules;
wherein said brew ring is circular and comprises stainless steel;
wherein said brew ring frictionally-fits about a periphery of a brewing basket of a coffee maker;
wherein said brew ring frictionally-fits on an outside or outside circumference of the periphery of said brewing basket of said coffee maker;
wherein said brew ring is fit to a bottom-point-circumference on a cylindrical version of said brewing basket;
wherein said brew ring comprises a timer and/or an activation button and/or a temperature sensor;
wherein said low voltage direct current source powers said brew ring allowing said ultrasonic waves to be emitted;
wherein said low voltage direct current source comprises a watch battery;
wherein said brew ring comprises a height of about ½ inch and a width of about ½ inch.
wherein said brew ring is tunable to a user-preferred frequency to optimize folding of said coffee grounds during said coffee brewing episode;
wherein said brew ring is tunable to said user-preferred frequency to optimize continuous said folding of said coffee grounds with incoming said water through 360 degrees during said coffee brewing episode;
wherein said agitation of said coffee grounds by said ultrasonic waves creates an increased pulsated-distance between each of said coffee grounds thereby creating a greater surface area contact of water with said coffee grounds; and
wherein said greater surface area contact of said water with said coffee grounds allows fewer coffee grounds to be used than in a traditional process during said coffee brewing episode and yet supply a fully flavored coffee of at least a same quantity as said traditional process.
